(19) United States
(12) Patent Application Publication
(10) Pub. No.: US 2002/0044819 A1
(43) Pub. Date: Apr. 18, 2002

(54) Case binder with living hinge

(76) Inventor: Ellis N. Shamoon, Dallas, TX (US)

Correspondence Address: DANIEL V THOMPSON, 12225 GREENVILLE AVENUE, SUITE 995, DALLAS, TX, 75243

(21) Appl. No.: 09/683,307

(22) Filed: Dec. 12, 2001

Related U.S. Application Data
(63) Continuation-in-part of application No. 09/710,464, filed on Nov. 10, 2000.

(51) Int. Cl. B42F 13/00

(52) U.S. Cl. 402/73

(57) ABSTRACT

A document carrying device has a rigid case formed of upper and lower case halves. The lower and upper case halves are joined together by a hinge wall and lower and upper living hinges. The lower and upper case halves and the hinge wall are complementary to form a substantially closed enclosure when aligned with each other. A ring binder chassis is fixed inside the case to an inner surface of the hinge wall.

### CROSS REFERENCE TO RELATED APPLICATIONS

This is a continuation-in-part of patent application No. 09/710,464, filed Nov. 11, 2000.

### BACKGROUND OF INVENTION

The present invention relates to document carrying devices, and more particularly to a device with ring binder chassis integrated into a hard-cased enclosure with hinged and latchable complementary case halves.

Ring binders combined with protective enclosures are known in the art.

U.S. Pat. Nos. 2,562,518, 5,738,460, and 5,916,280 disclose zipper-closeable, flexible enclosure ring binders.

U.S. Pat. Nos. 2,333,523 and 5,676,443 disclose two complete ring binders enclosed in a flexible case closed by a flap and snaps.

U.S. Pat. No. 2,881,008 discloses a ring binder combined with an easel.

U.S. Pat. No. 1,978,926 discloses a sample case with rigid samples carried by a ring binder chassis and flexible samples carried in a fixed mounting.

These prior art devices are difficult and expensive to manufacture, requiring the sewing of leather and cloth materials and typically using long zippers. Being flexible, they are awkward to carry and difficult to store in an upright position.

With the advent of precision injection molding of plastic, it is now possible to make an extremely durable, colorful, low weight, and low cost rigid enclosure. The incorporation of a ring binder chassis into such an enclosure would offer a superior document carrying and storage device compared to the prior art.

### SUMMARY OF INVENTION

A ring binder chassis is integrated into an injection-molded plastic, rigid, enclosure case, with complementary case halves joined by a living hinges on one side and latches on the side opposite the hinges.

### BRIEF DESCRIPTION OF DRAWINGS

A more complete understanding of the invention and its advantages will be apparent from the Detailed Description taken in conjunction with the accompanying Drawings, in which:

FIG. 1 is a left-top perspective view of a document carrying device of the present invention.

FIG. 2 is a view similar to FIG. 1 with the case open.

FIG. 3 is a front-top perspective view with the case open.

FIG. 4 is a top view.

FIG. 5 is a side view.

FIG. 6 is a partially broken away end of a hinged corner.

FIG. 7 is a partial top view of a page holder.

FIG. 8 is a sectional view taken along lines 8-8 of FIG. 7.

### DETAILED DESCRIPTION

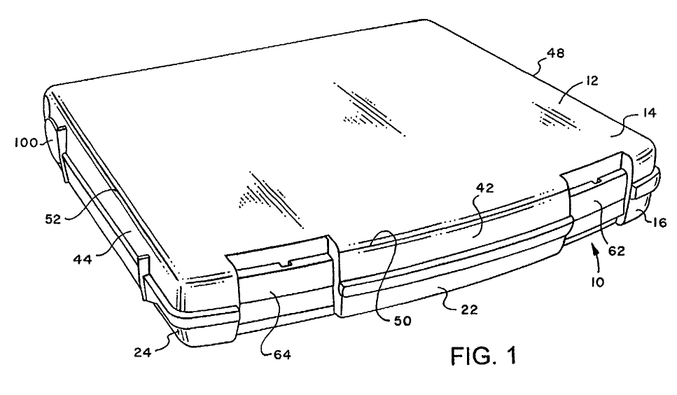

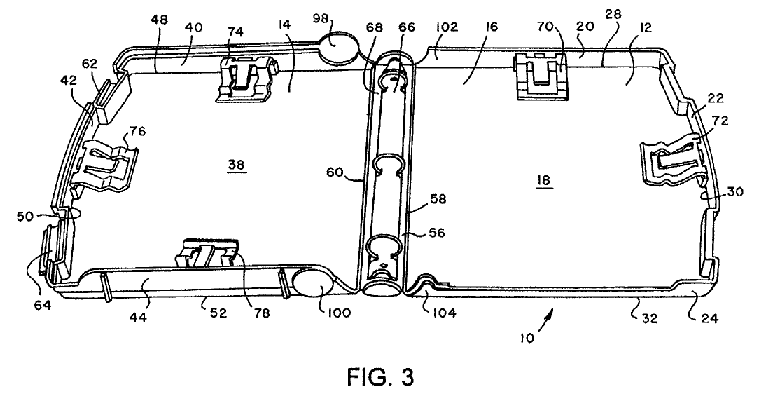

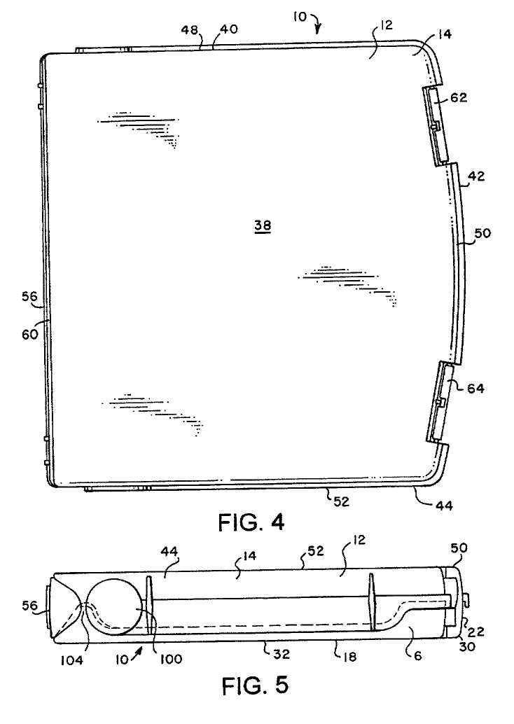

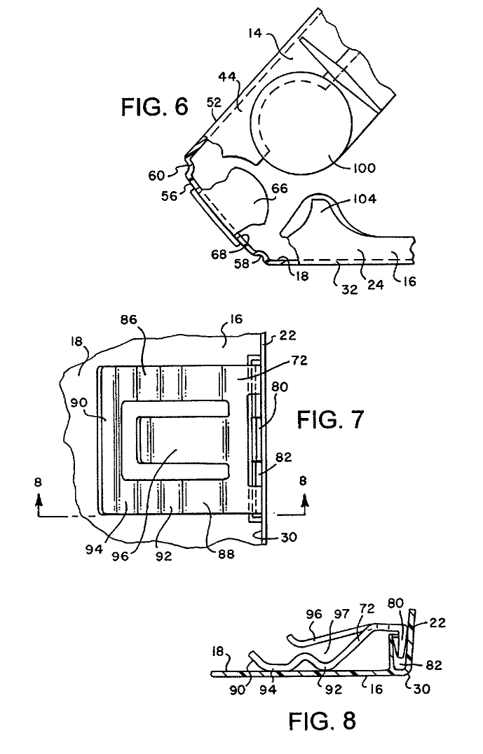

Referring to FIGS. 1-8, where like numerals indicate like and corresponding elements, document carrying device 10 includes a rigid case 12 formed of upper and lower case halves 14, 16. The lower case half 16 is formed of a rectangular lower case half main wall 18 and three lower case half side walls 20, 22, 24 extending perpendicularly from side edges 28, 30, 32, respectively, of the lower case half main wall 18.

Similarly, the upper case half 16 is formed of a rectangular upper case half main wall 38 and three upper case half side walls 40, 42, 44 extending perpendicularly from side edges 48, 50, 52, respectively, of the upper case half main wall 38.

The lower and upper case halves 14, 16 are joined together by a hinge wall 56 and lower and upper living hinges 58, 60. As is well known in the injection-molding art, a living hinge is a thin section of plastic formed when two hinged parts are simultaneously injection-molded with a section of the mold specially formed for that purpose.

The lower and upper case half side walls 20, 22, 24, and 40, 42, 44, and the hinge wall 56, are complementary to form a substantially closed enclosure when aligned with each other.

The upper and lower case halves 14, 16 are selectively connectable by latches 62, 64 along a complementary pair of one of the lower case half side walls, wall 22, and one of the upper case half side walls, wall 42. A ring binder chassis 66 is fixed inside the case 12 to an inner surface 68 of the hinge wall 56.

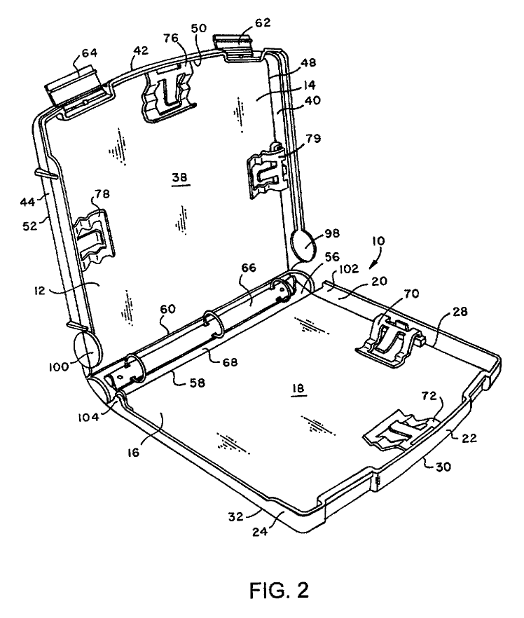

Referring now to FIGS. 2, 3, 7 and 8, page holders 70, 72, 74, 76, 78 are formed of flexible plastic and provided to hold edges of papers to upper and lower case halves 14, 16. As shown in FIGS. 7 and 8, page holder 72, which is typical of page holders 70, 72, 74, 76, 78, has a base tab 80 removably retained by a pocket 82 in wall 22. U-shaped hold-down portion 84 has two side sections 86, 88 and an end section 90. Side sections 86, 88 each are curved to have an inner contact area 92 and an outer contact area 94. End section 90 is upwardly bent to enable insertion of one or more paper edges. Central finger 96 is provided to hold a writing instrument such as a pen or pencil in space 97 between the central finger 96 and the hold-down portion 84.

Registers 98 and 100 are provided to permit automatic alignment of upper and lower case halves 14, 16 as they are moved to the closed position. Register 98 engages a registration portion 102 of wall 20, while register 100 engages a registration portion that is an upstanding registration tab 104 of wall 24. Registers 98, 100 are illustrated as circular in appearance, which appearance is aesthetic only. The essential function is that registers 98, 100 capture registration portion 102 and registration tab 104, respectively, as upper and lower case halves 14, 16 as they are moved to the closed position, thereby enabling effortless alignment of the case half edges.

As best shown in FIG. 2, one of the lower case half side walls 24 has a central section reduced in height relative to the other lower case half side walls 20, 22 in order to permit ease of writing on papers supported by the lower case half main wall 18.

It will be understood that each of the elements described above, or two or more together, may also find a useful application in other types of constructions differing from the type described above.

While the invention has been illustrated and described as embodied in a braking systems, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

Whereas, the present invention has been described with respect to a specific embodiment thereof, it will be understood that various changes and modifications will be suggested to one skilled in the art and it is intended to encompass such changes and modifications as fall within the scope of the appended claims.

1] a document carrying device comprising:
a rigid case formed of upper and lower case halves;
the lower and upper case halves joined together by a hinge wall and lower and upper living hinges;
the lower and upper case halves and the hinge wall being complementary to form a substantially closed enclosure when aligned with each other; and
a ring binder chassis fixed inside the case to an inner surface of the hinge wall.

2] The device of claim 1 with the upper and lower case halves selectively connectable by latches.

3] A document carrying device comprising: a rigid case formed of upper and lower case halves; the lower case half formed of a rectangular lower case half main wall and three lower case half side walls extending perpendicularly from side edges of the lower case half main wall; the upper case half formed of a rectangular upper case half main wall and three upper case half side walls extending perpendicularly from side edges of the upper case half main wall; the lower and upper case halves joined together by a hinge wall and lower and upper living hinges; the lower and upper case half side walls and the hinge wall complementary to form a substantially closed enclosure when aligned with each other; and a ring binder chassis fixed inside the case to an inner surface of the hinge wall.

4] The device of claim 3 with at least one of the lower case half side walls having a central section reduced in height relative to the other lower case half side walls in order to permit ease of writing on the lower case half main wall.

5] A document carrying device comprising: a rigid case formed of upper and lower case halves; the lower and upper case halves joined together by a hinge; the lower and upper case halves and hinge being complementary to form a substantially closed enclosure when aligned with each other; and a ring binder chassis fixed inside the case to an inner surface of the enclosure; and at least one page holder formed of flexible plastic and connected to one of the upper or lower case halves, the page holder being provided to hold edges of papers to one of the upper or lower case halves.

6] The device of claim 5 with a plurality of page holders.

7] The device of claim 5 with the page holder having a base tab removably retained by a pocket in a wall of one of the upper or lower case halves.

8] The device claim 5 with the page holder having a U-shaped hold-down portion, the hold-down portion having two side sections and an end section.

9] The device of claim 6 with the side sections each are curved to have an inner contact area and an outer contact area.

10] The device of claim 6 with the end section being upwardly bent to enable insertion of one or more paper edges.

11] The device of claim 5 with the page holder including a central finger provided to hold a writing instrument such as a pen or pencil in a space between the central finger and a hold-down portion of the page holder.

12] The device of claim 1 with at least one register on one of the lower or upper case halves provided to permit automatic alignment of the upper and lower case halves as they are moved to the closed position, the register engaging a registration portion of the other of the lower or upper case halves.

13] The device of claim 12 with a plurality of registers and registration portions.

14] The device of claim 12 with the registration portion being an upstanding registration tab.

15] The device of claim 3 with at least one register on one of the lower or upper case halves provided to permit automatic alignment of the upper and lower case halves as they are moved to the closed position, the register engaging a registration portion of the other of the lower or upper case halves.

16] The device of claim 15 with a plurality of registers and registration portions.

17] The device of claim 16 with the registration portion being an upstanding registration tab.

18] A document carrying device comprising:
a rigid case formed of upper and lower case halves;
the lower case half formed of a rectangular lower case half main wall and three lower case half side walls extending perpendicularly from side edges of the lower case half main wall;
the upper case half formed of a rectangular upper case half main wall and three upper case half side walls extending perpendicularly from side edges of the upper case half main wall;
the lower and upper case halves joined together by a hinge wall and lower and upper living hinges;
the lower and upper case half side walls and the hinge wall being complementary to form a substantially closed enclosure when aligned with each other;
a ring binder chassis fixed inside the case to an inner surface of the hinge wall;
with the upper and lower case halves selectively connectable by latches along a complementary pair of one of the lower case half side walls and one of the upper case half side walls;
at least one page holder formed of flexible plastic and connected to one of the upper or lower case halves, the page holder being provided to hold edges of papers to one of the upper or lower case halves;
with the page holder having a base tab removably retained by a pocket in a wall of one of the upper or lower case halves;
with the page holder having a U-shaped hold-down portion, the hold-down portion having two side sections and an end section;
with the side sections each are curved to have an inner contact area and an outer contact area;
with the end section being upwardly bent to enable insertion of one or more paper edges;
with the page holder including a central finger provided to hold a writing instrument such as a pen or pencil in a space between the central finger and a hold-down portion of the page holder;
with at least one register on one of the lower or upper case halves provided to permit automatic alignment of the upper and lower case halves as they are moved to the closed position, the register engaging a registration portion of the other of the lower or upper case halves.

19] The device of claim 17 with the registration portion being an upstanding registration tab.

20] The device of claim 17 with a plurality of page holders.
